(19) United States
(12) Patent Application Publication
(10) Pub. No.: US 2019/0229461 A1
(43) Pub. Date: Jul. 25, 2019

(54) POWER CONNECTOR WITH TERMINAL

(71) Applicant: Molex, LLC, Lisle, IL (US)

(72) Inventors: Chiu-Ming LU, Lisle, IL (US); Ronald C. HODGE, Aurora, IL (US); Jeffrey GAUMER, Naperville, IL (US)

(73) Assignee: Molex, LLC, Lisle, IL (US)

(21) Appl. No.: 16/311,830

(22) PCT Filed: Jun. 23, 2017
(86) PCT No.: PCT/US2017/038958

§ 371 Date: Dec. 20, 2018

Related U.S. Application Data
(60) Provisional application No. 62/354,203, filed on Jun. 24, 2016.

(51) Int. Cl. H01R 13/53; H01R 13/11; H01R 13/44; H01R 13/42; H01R 13/502

(52) U.S. Cl. CPC H01R 13/53; H01R 13/114; H01R 13/502; H01R 13/42; H01R 13/44

(57) ABSTRACT

The present disclosure provides a conductive terminal and an electrical connector assembly. A power electrical connector is provided for transmitting electrical signals from a pair of cables, such as high current capable cables, to an associated member. The high power electrical connector includes an insulative housing and a pair of contact terminals with an additional insulative member that provides a barrier against electrical shock. In such cases a user is prevented for inadvertently touching the power terminals during use.

### RELATED APPLICATIONS

This application claims priority to U.S. Provisional Application No. 62/354,203 filed on Jun. 24, 2016 which is incorporated herein by reference in its entirety.

### TECHNICAL FIELD

This disclosure relates to the field of power connectors, more specifically a power connector having touch safe contacts.

### DESCRIPTION OF RELATED ART

Power connectors are commonly used in high current applications. These applications typically involve heavy equipment and machinery. With high current connectors, a user can he exposed to these high current levels which can he dangerous. Accordingly, certain individuals would appreciate a way to offer increased user protection and guard against unintentional exposure to high currents to power connector designs.

### SUMMARY

A power connector system is provided. The power connector system includes a plug connector and a receptacle connector. Each connector includes a housing and a conductive terminal retained in a cavity formed in the housing. Each terminal includes a connecting portion generally positioned at the mating end of the housing when the terminals are inserted into the cavity. The male terminal includes an insulative piece attached to the connecting portion and in operation, when retained in the housing minimizes the exposure of the conductive portion of the terminal through the front mating opening in the housing. The female terminal is positioned within a protective silo formed in the receptacle housing. The receptacle housing includes a mating opening configured to receive the plug housing and an opening. The silo extends into the opening and is configured to engage the male terminal therein. The contacting portion of the female terminal includes an insulative piece configured to be positioned within the contacting portion of the female terminal and also extend into the center area of the male terminal when fully mated together.

### BRIEF DESCRIPTION OF THE DRAWINGS

The present invention is illustrated by way of example and not limited in the accompanying figures in which like reference numerals indicate similar elements and in which:

FIG. 1 is a perspective view of the power connector according to the disclosure;

FIG. 2 is an unmated perspective of the power connector of FIG. 1;

FIG. 3 is an mixed perspective view of the unmated power connector of FIG. 1;

FIG. 4 is an explode view of the receptacle of the power connector of FIG. 1;

FIG. 5 is an explode view of the plug of the power connector of FIG. 1;

FIG. 6 is an exploded view of the receptacle terminal of the disclosure;

FIG. 7 is an exploded view of the plug terminal of the disclosure;

FIG. 8 is a sectional view of the unmated power connector of FIG. 2;

FIG. 9 is a sectional view of the power connector of FIG. 1;

FIG. 10 is a perspective view of an unmated pair of terminals of the power connector;

FIG. 11 is a perspective view of a mated pair of terminals of the power connector;

FIG. 12 is an alternate perspective view of the receptacle with a probe;

FIG. 13 is a sectional view of the receptacle and probe of FIG. 12;

FIG. 14 is an alternate perspective view of the plug with a probe;

FIG. 15 is a sectional view of the plug and probe of FIG. 14;

FIG. 16 is a perspective view of an alternate embodiment of the power connector system of the present disclosure;

FIG. 17 is an exploded view of the receptacle of the power connector system of FIG. 16;

FIG. 18 is an exploded view of the plug of the power connector system of FIG. 16.

### DETAILED DESCRIPTION

The detailed description that follows describes exemplary embodiments and is not intended to be limited to the expressly disclosed combination(s). Therefore, unless otherwise noted, features disclosed herein may be combined together to form additional combinations that were not otherwise shown for purposes of brevity.

The appended figures illustrate an embodiment with features that can be included in a power connector. As can be appreciated, while a wire connected system is disclosed other systems that employ circuit boards and panel mounting options could also be provided.

As can be appreciated, the connector system includes a plug connector and receptacle connector. Each of the connectors include a housing formed from an insulative material including a cavity. A conductive terminal is disposed within each cavity and cooperatively engage each other in an electrical fashion.

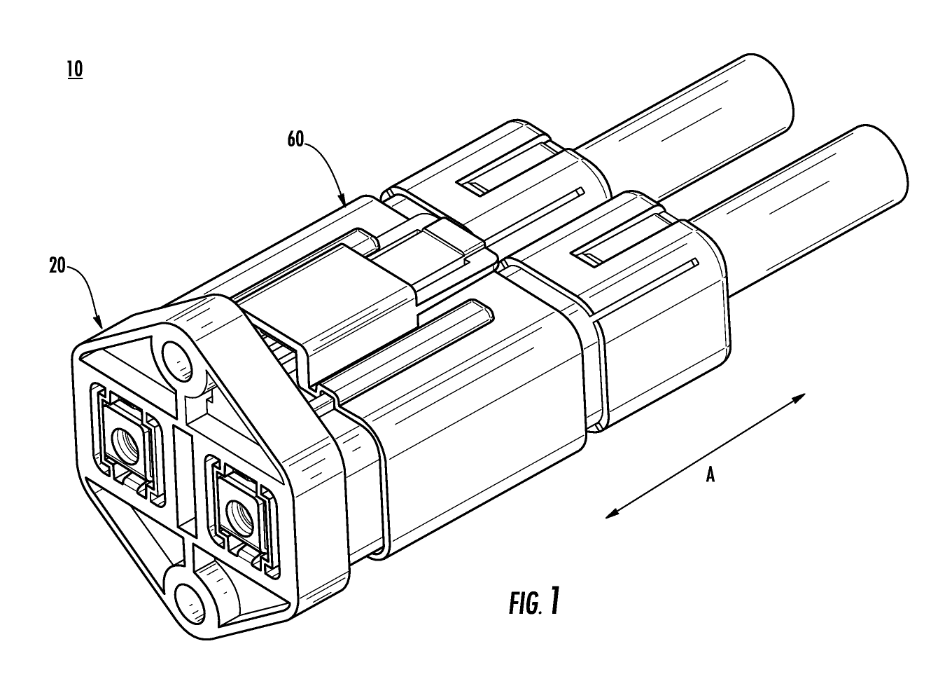

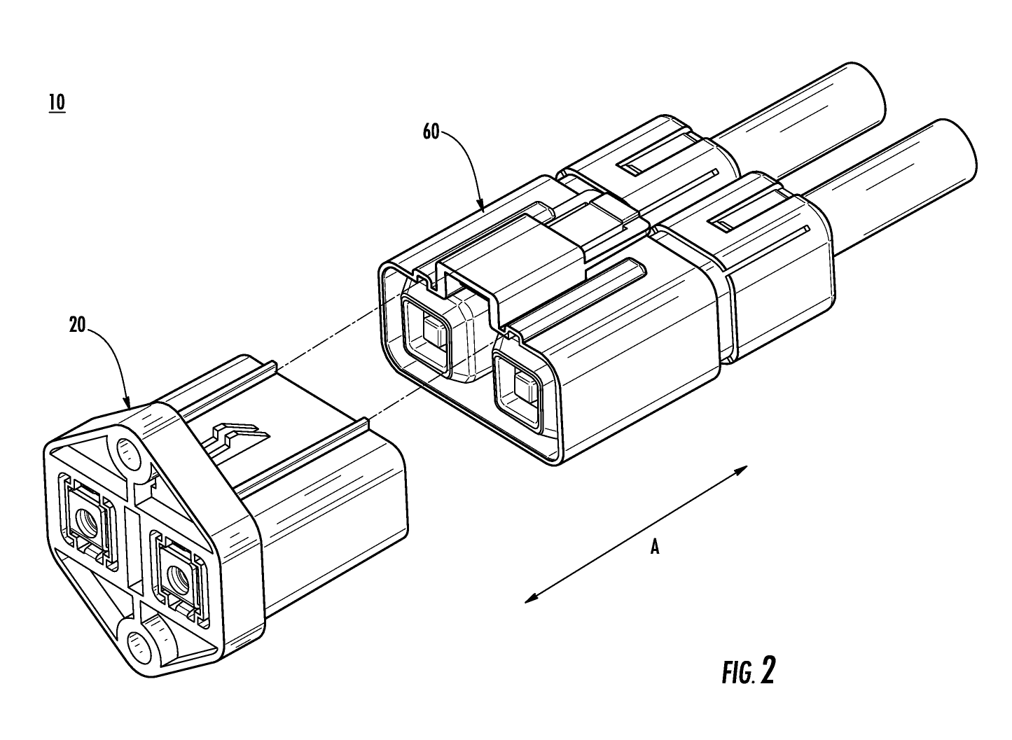

As best shown in FIGS. 1-3 an embodiment of the present disclosure is illustrated. The present disclosure provides a power connector system 10 including a first connector or receptacle connector 60 that is typically referred to as a receptacle 60 and a second connector or plug connector 20 that is typically referred to as a plug 60. As illustrated, the plug 20 and receptacle 60 are configured to be connected together or mated along a mating direction A. As shown, the plug is mounted to a bus bar (not shown) and the receptacle 60 is attached to cables 85. Other configurations are contemplated such as board to board and wire to wire arrangements or any combination of the above.

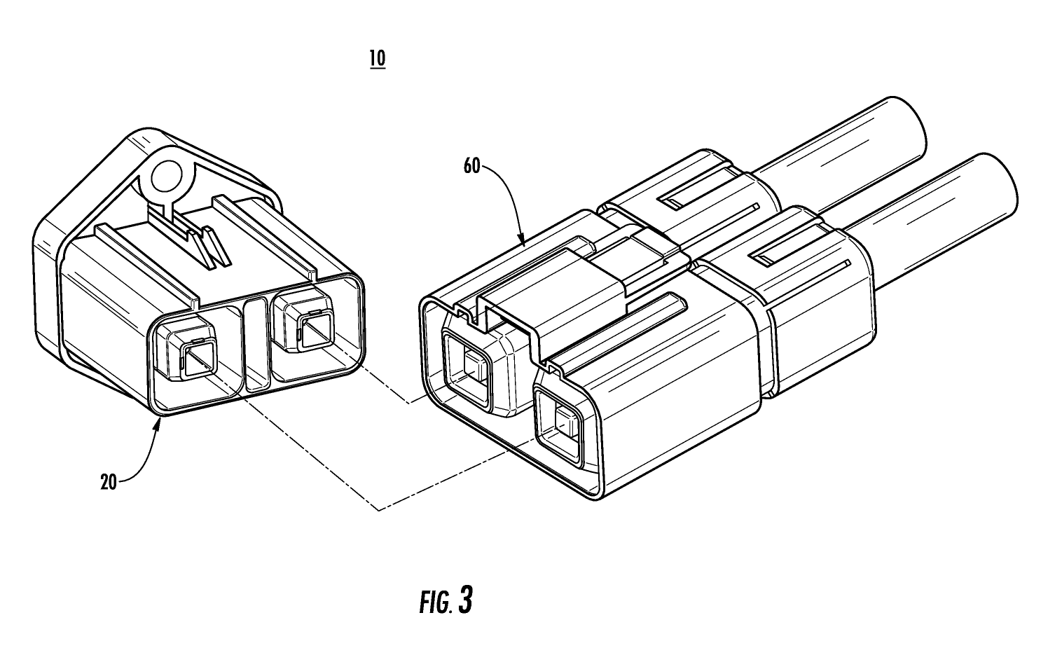

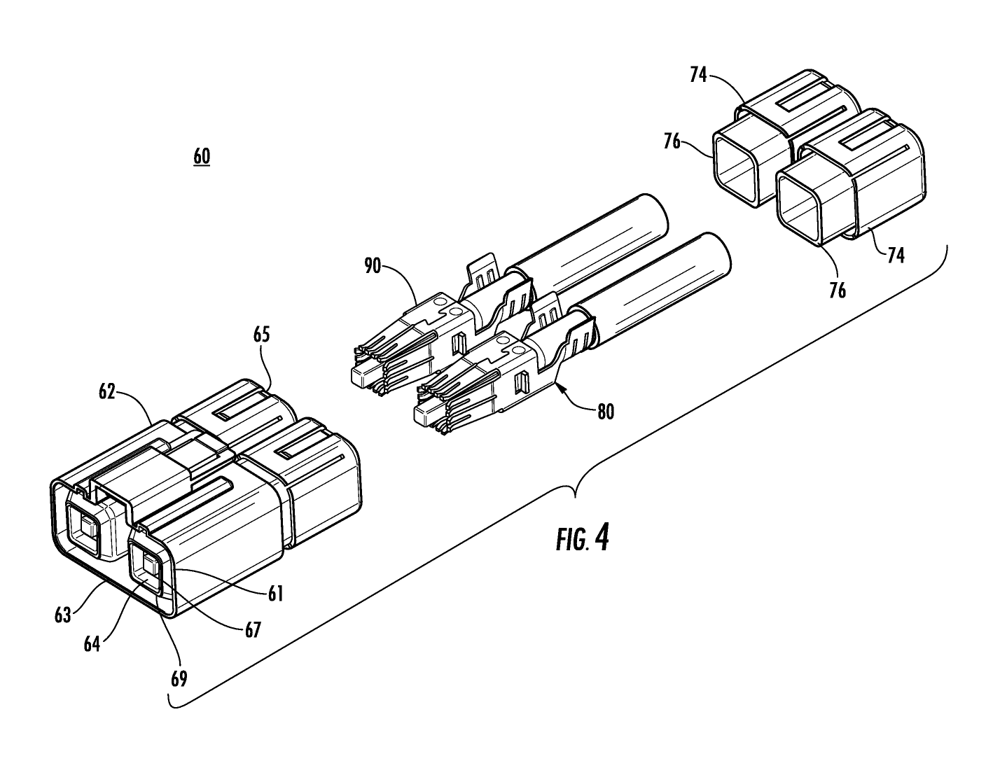

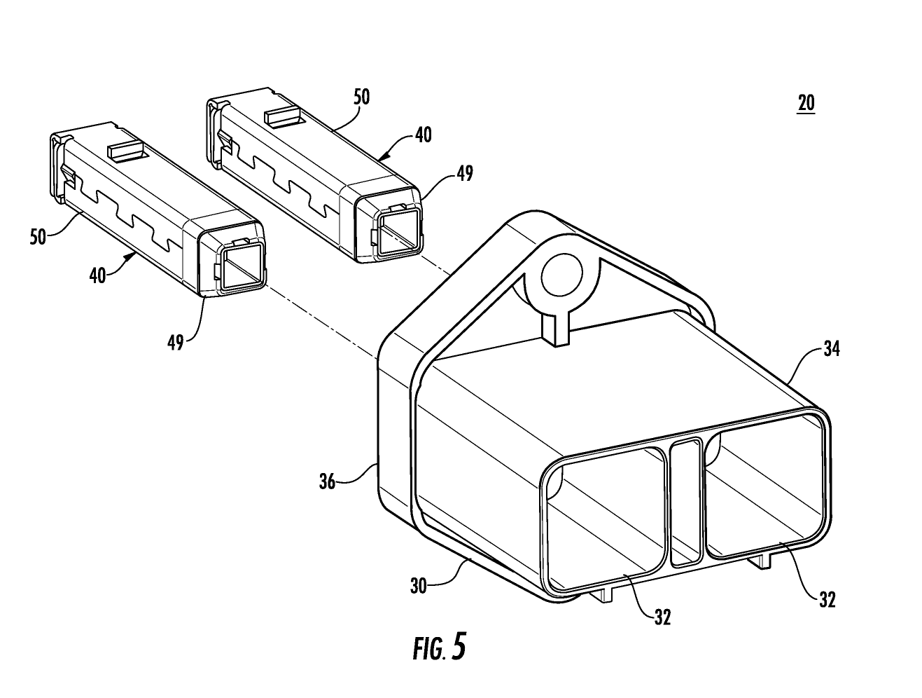

As depicted in FIG. 4, the receptacle 60 includes a first housing 62, a first terminal assembly 80 and a terminal retention cap 74. As shown in FIG. 5 the plug 20 includes a second housing 30 and a second terminal assembly 40. As best illustrated in FIG. 3, the plug 20 and the receptacle 60 are configured to be connected or mated together in an interleaving manner.

As illustrated, the receptacle 60 includes a housing 62 formed from an insulative material having an opening 63 configured to receive a cooperating portion of a housing 30 of the plug 20. A pair of silos 69 are formed in the opening 63 and extend along the mating direction A. In the embodiment shown, the end portion 67 of each silo 69 is generally flush with the end 61 of the receptacle housing 62. In certain instances, the silo 69 may be recessed in the opening 63 or extend beyond the housing 62. The housing 62 includes a mounting section 65 opposite the opening 63 formed along the mating direction A. A cavity 64 is formed in the silo 69 and communicates with the mounting section 65.

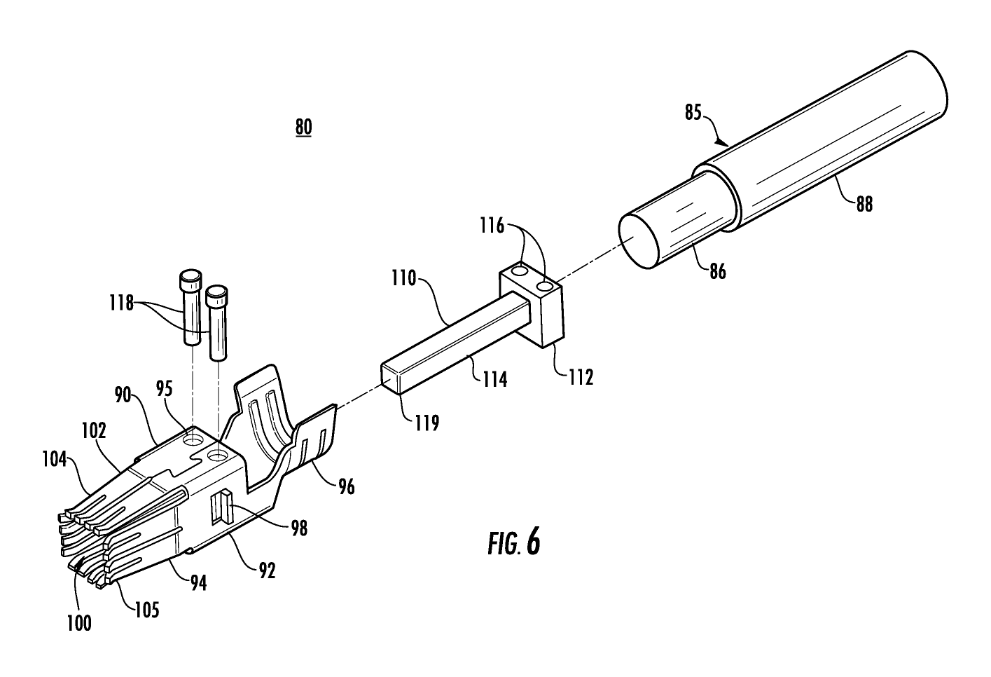

As best shown in FIGS. 4 and 6, a first terminal assembly 80 includes an electrically conductive female terminal or receiving terminal 90 with a cable 85 secured thereto. For the sake of brevity, the electrically conductive female terminal will be referred to as terminal 90. An insulative peg 110 is disposed and secured within the terminal 90. The terminal 90 is stamped and formed from electrically conductive sheet material of copper or similar copper based alloy. The terminal 90 includes a base portion 92 with a contact portion 94 extending from a first area of the base portion 92 along a mating direction and a securing portion 96 extending from a second area of the base portion 92. The terminal 90 is generally formed in a tubular shape with an exterior periphery defined around the base portion 92. In the embodiment shown the periphery is defined in a rectangular fashion, in particular a square. Other peripheries are considered such as circular.

Spring fingers 104 are formed in the contact portion 94 extending from the base portion 92 are formed along the periphery of the base portion 92 and defined an interior space 100. Each spring finger 104 includes a contact point 105 at a distil end of the spring finger 104. A securing portion 96 extends from a second area of the base portion 92 and includes a “U” shaped section. The “U” shaped section is configured to receive a conductor 86 of a cable assembly 85 and upon deformation of the “U” shaped section crimps the conductor 86 of the cable assembly 85 to the terminal 90. In the embodiment shown a crimp is employed to secure the conductor to the terminal, other connecting methods are considered such as a screws, bolts or welding. A retention tab 98 is formed from a side of the base portion 92 of the terminal 90.

The terminal 90 further includes an insulating blocking peg 110 that is captivated in the interior space 100 of the terminal 90. The blocking peg 110 extends in the mating direction A along the contact portion 94 of the terminal 90. The insulating peg 110 includes a base 112 formed at one end of the peg 110 that is adapted to engage the interior periphery sides of the female terminal and includes a projection 114 extending from the base 112 having a blocking end 119 disposed at the distal portion of the projection 114. A pair of holes 116 are formed through the base 112 that are aligned with similar holes 95 formed in the base portion 92 of the terminal 90 when the insulating peg 110 is inserted into the space 100 of the terminal 90. Upon insertion, the base 112 of the insulating peg 110 conforms to the interior periphery of the base portion 92 of the terminal 90. A pair of pins 118 are inserted into the opening 95 in the base portion 92 of the terminal 90 and protrude through the base 112 of the insulating per 110 securing the insulating peg 110 to the base portion 92.

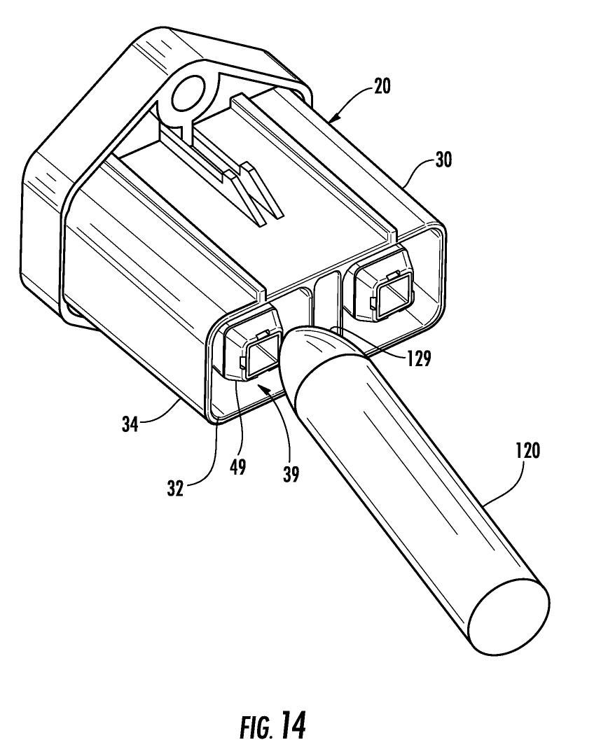

As shown in FIGS. 4 and 13, upon insertion of the terminal 90 into the housing 62, the retention tabs 98 formed on the terminal base 92 engage a shoulder 75 formed in the cavity and prevent the terminal from further movement during insertion. The retention cap 74 is attached to the housing 62 with a blocking wall 76 extending into the cavity and engaging the retention tab 98 of the terminal and locking the terminal 90 in the housing 62. The retention cap 74 is secured to the housing by a locking latch. Upon complete assembly of the connector assembly 60, several regions are now formed. A receiving slot 89 is defined between the interior of the silo 69 and the projection 114 of the peg 110. The spring fingers 104 of the terminal 90 are disposed in the receiving slot 89 with the contact points 105 adjacent the projection 114.

As illustrated, the plug 20 includes a housing 30 formed from an insulative material having a mating section 34 configured to mate with the opening 63 formed in the housing 62 of the receptacle 60. The housing 30 includes a mounting section 36 opposite the mating section 34 and a pair of cavities 32 formed in the mating section 34 and extending through the housing 30 along a mating direction A to the mounting section 36. Each terminal assembly 40 is inserted and retained in the mounting section 36 of the housing 30.

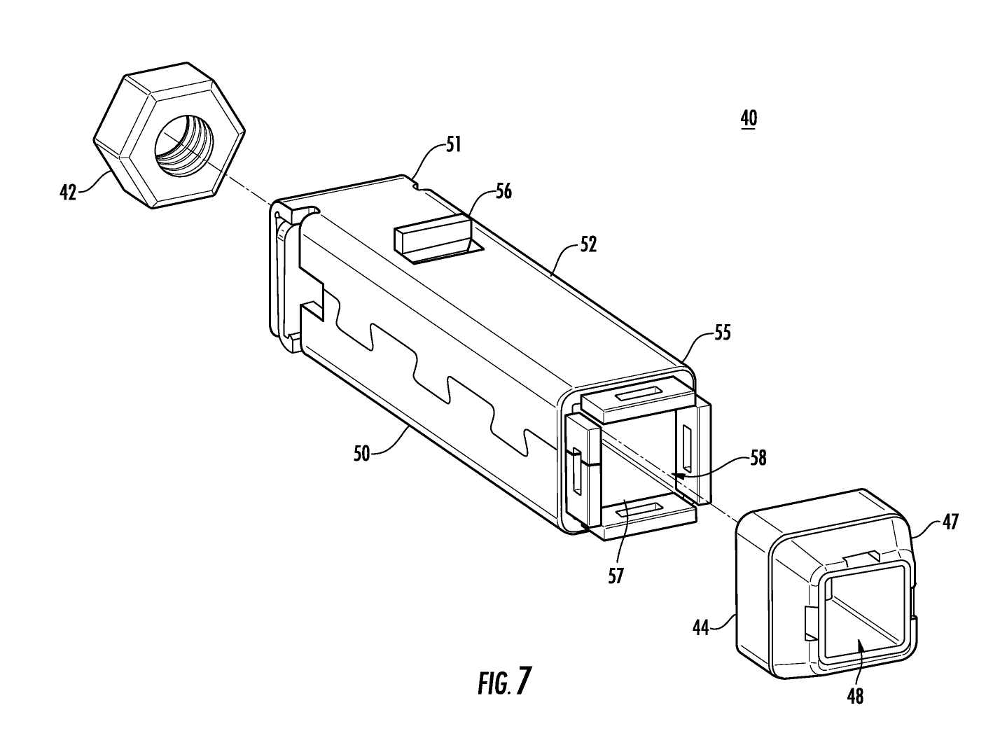

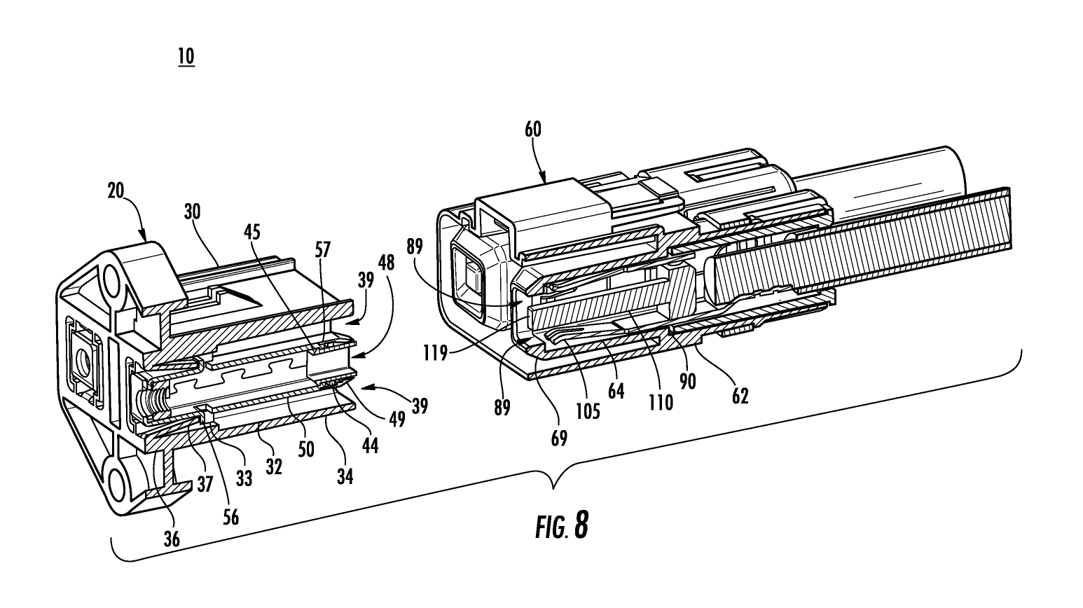

As best shown in FIGS. 5 and 7, a second terminal assembly 40 includes an electrically conductive male terminal or insertion terminal 50. For the sake of brevity, the electrically conductive male terminal will be referred to as terminal 50. The terminal 50 is configured with a periphery that matches the periphery of the first terminal 90 and is adapted to mate with the first terminal 90. An insulative endcap 44 is disposed on the mating end 55 of the terminal 50 and secured by snaps 45 formed on the endcap 44 engaging a shoulder 57 in the space 58 of the terminal 50 as depicted in FIG. 8. The endcap further includes an aperture 48 that communicates with the internal space 58 of the terminal 50.

The terminal 50 is stamped and formed from electrically conductive sheet material of copper or similar copper based alloy. The terminal 50 further includes a base portion 51 configured to captivate a retention nut 42 and has a retention tab 56 extending from a side peripheral surface. A contact surface 52 conforms to the periphery and is exposed on the exterior of the terminal 50.

As shown in FIG. 8, upon insertion of the terminal 50 into the housing 30, the retention tabs 56 formed on the mounting section 36 engage a shoulder 33 formed in the cavity of the housing 30 and prevent the terminal 50 from further movement during insertion. A retention finger 37 is formed in the cavity of the housing 30 and deflects upon insertion of the terminal 50 and upon full insertion of the terminal 50 the retention finger 37 returns to its un-deflected state and engages the retention tab 56 locking the terminal 50 in the mounting section 36 of the housing 30. Upon complete assembly of the connector assembly 20, a gap 39 is defined between the interior of the housing 30 and the terminal 50 of the plug 20.

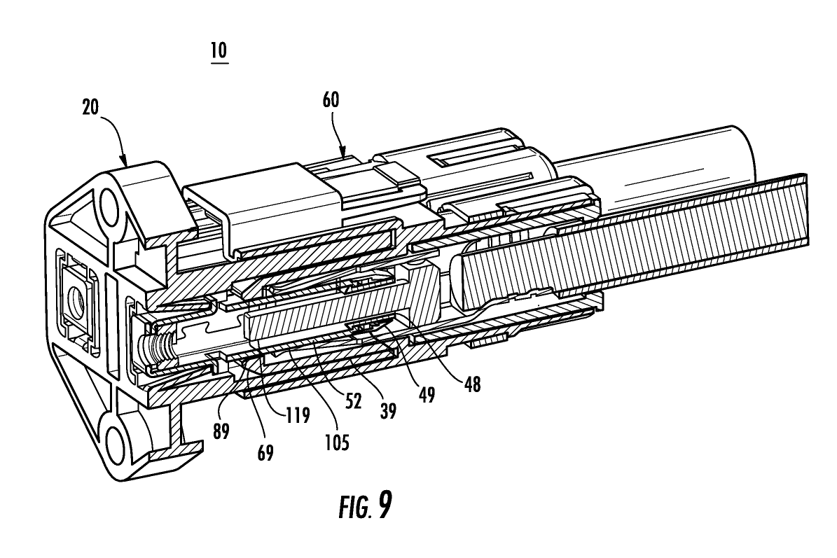

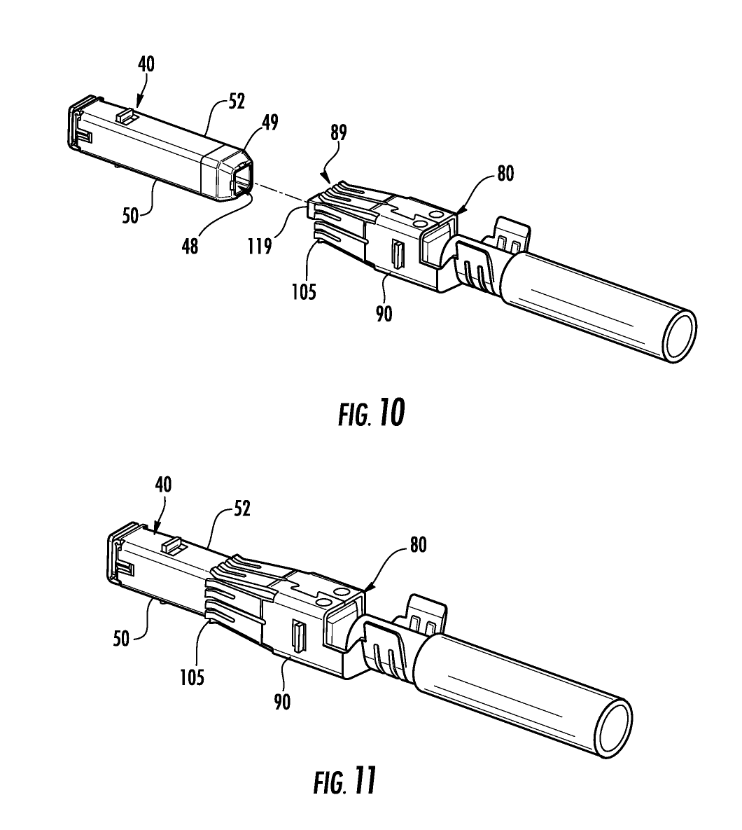

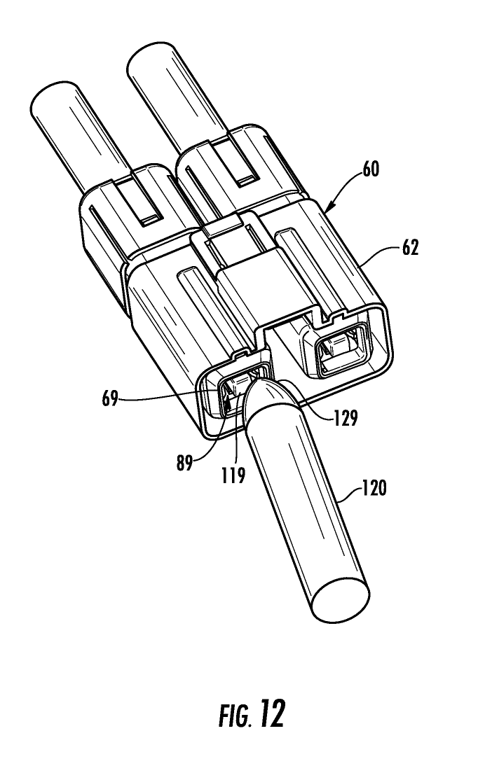

As illustrated in FIGS. 8-11, the mating of the connectors 20, 60 will now be discussed. The plug 20 and receptacle 60 are brought into close proximity and the mating section 34 of the plug housing 30 is aligned with the opening 63 of the receptacle housing 62. The plug 20 is inserted into the opening 63 of the receptacle 60 in which the mating section 34 of the housing 30 extends into the opening 63 of the housing 62. At this time, the silo 69 enters the gap 39 and the blocking end 119 of the peg 110 enters the aperture 48 while the second terminal 50 simultaneously enters the receiving slot 89. The terminal 50 engages the spring fingers disposed in the slot making intimate electrical contact. Upon full insertion of the plug 20 into the receptacle 60, the connectors 20, 60 are removably locked together. As shown in FIGS. 10-11, the terminal assemblies 40, 80 are illustrated during mating with the housings removed for clarity. The tubular shaped terminals 50, 90 are mated together in an interleaving fashion. The blocking end 119 is received through the aperture 48 and the terminal 50 is received within the receiving slot 89 in the opening of the terminal 90. The contact points 105 of the spring fingers engage the outer conductive contact surface 52 of the terminal 50.

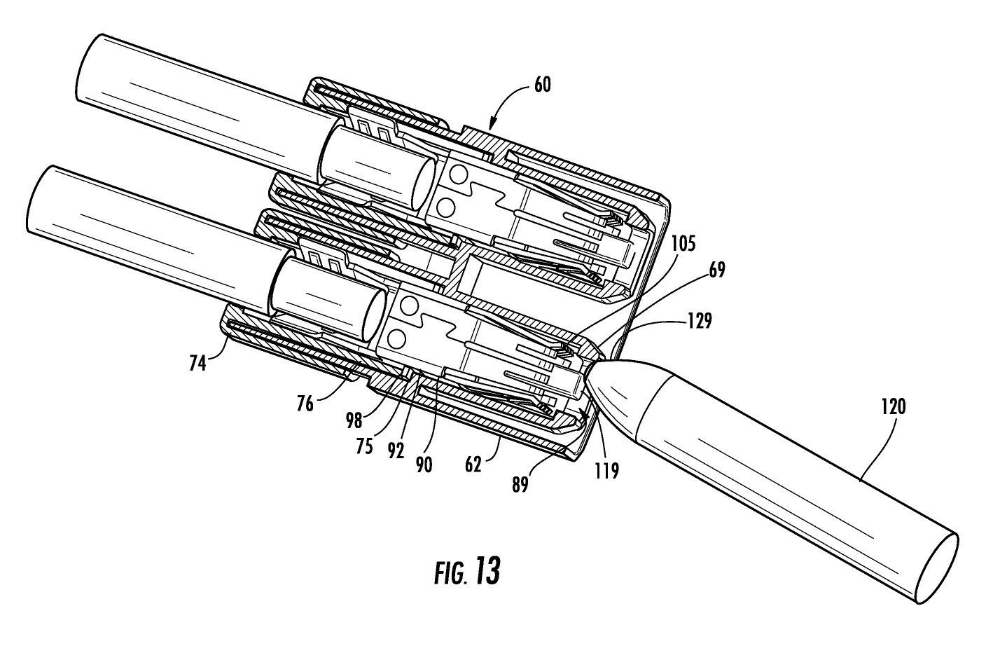

FIGS. 12-15 illustrate a touch safe aspect of the power connector assembly 10. Each of the plug 20 and receptacle 60 have a defined restriction area that prevents accidental touching by an operator or user. In this area a first distance is defined between adjacent insulative areas with an intermediate contact portion positioned there between. That is, there is minimal clearance between the conductive portions of the terminal and the insulating portions of the housings that retain the terminals therefore minimizing the chance of incidental contact of the terminal by an individual but simultaneously allowing the terminals to access the conductive portion spring fingers and electrically engage the female terminal

In this embodiment, a receptacle 60 as previously described and shown in FIGS. 12 and 13 is illustrated. The front mating area of the receptacle has a first distance that is defined by the receiving slot 89. This distance is determined by the space between the blocking end 119 of the peg 110 and the wall of the silo 69. As illustrated a finger probe 120 that conforms to International standards such as UL1977, UL 1950, CEI/IEC 60529, IEC 60950, UL 60950 or CSA C22.2 among others, is used to check and verify the touch safe zone. In use, these standards, effectively define a second distance that simulates a finger-tip 129 as depicted in FIG. 13. This distance can be a radial dimension or an effective distance across an arc that simulates the finger-tip. Compliance to the touch safe requirement is verified by attempting to access the conductive areas of the terminal with the finger probe, in this instance the receiving slot 89. In order to comply, the finger probe cannot make contact with the terminal which is blocked by the blocking end 119 of the peg 110 and the silo 69.

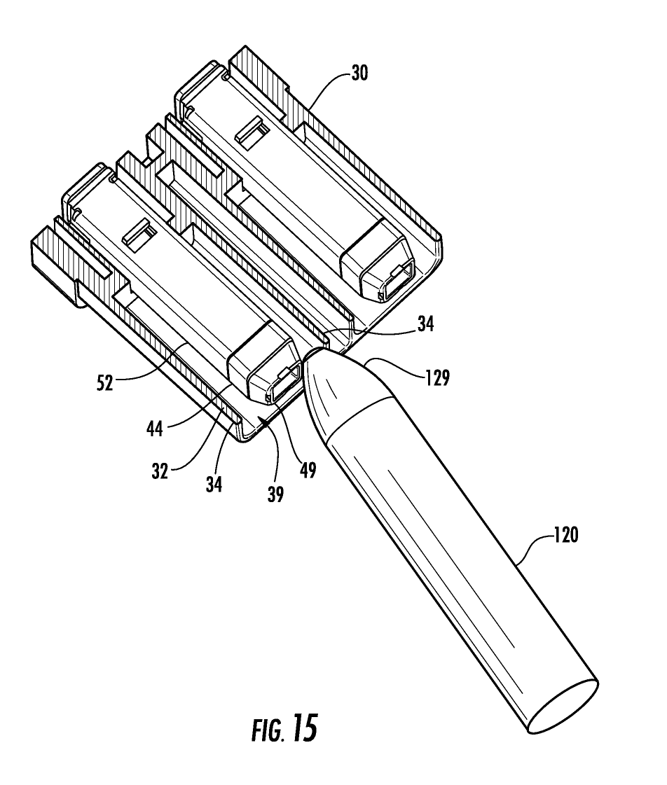

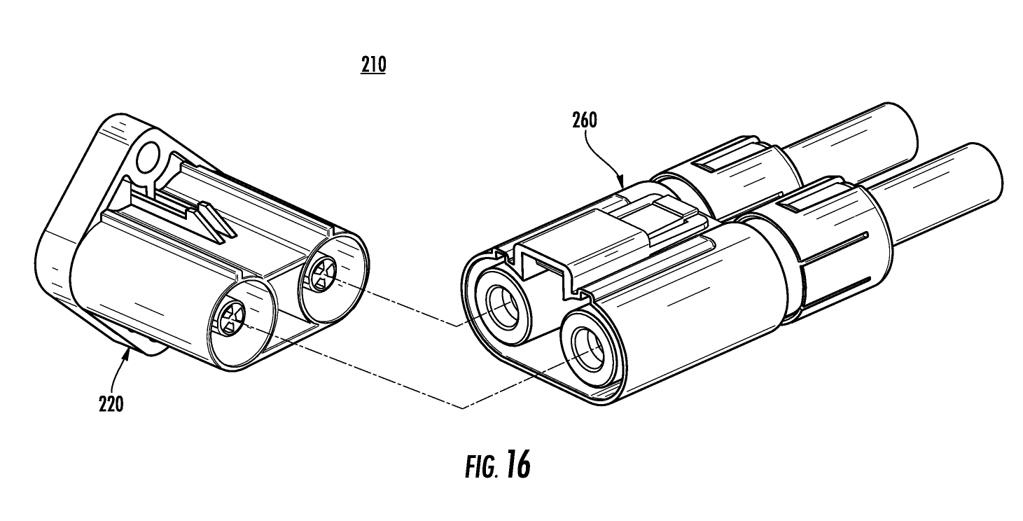

The plug 20 also includes a touch safe aspect similar to the receptacle which is illustrated in FIGS. 14-15. In this embodiment, the plug as previously described includes a front mating area 34 configured to be mated with the receptacle 60. A distance is defined between the interior wall of the cavity 34 formed in the plug housing 32 and the outermost portion 49 of the insulative endcap 44. As illustrated a finger probe 120 that conforms to the above identified standards is used to check and verify the touch safe zone. In use, these standards effectively define a second distance that simulates a finger-tip 129 as depicted in FIG. 15. Compliance to the touch safe requirement is verified by attempting to access the conductive areas of the terminal 50 with the finger probe 120, in this instance through the gap 39. In order to comply, the finger probe cannot make contact with the contact surface 52 which is blocked by the outermost portion 49 of the insulative endcap and interior wall of the cavity 32.

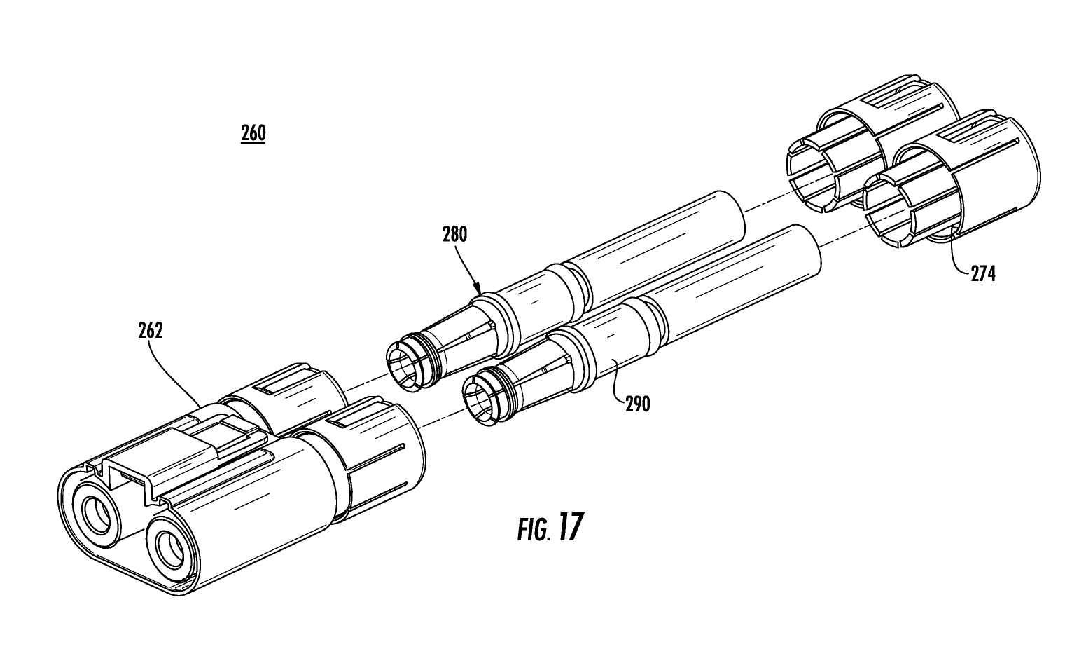

An alternative embodiment is shown in FIGS. 16-18 in which a touch safe connector assembly is shown that utilizes a circular tubular terminal system. As illustrated in FIG. 17, the receptacle includes a housing 262, a terminal assembly 280 and a retention cap 274. The terminal assembly 280 includes a circular terminal with a base portion and plurality of spring fingers extending from the periphery of the base portion along a mating direction. A ring surrounds the spring fingers that limit the deflection of the spring fingers and increases the connection force during mating with a complimentary engaging terminal received therein. Upon assembly of the receptacle 260, the housing includes an opening configured to allow entry of a mating terminal during mating. The opening is configured to restrict entry of a finger probe in proximity to the electrically conductive portion of the terminal in the housing and therefore defining the receptacle as touch safe.

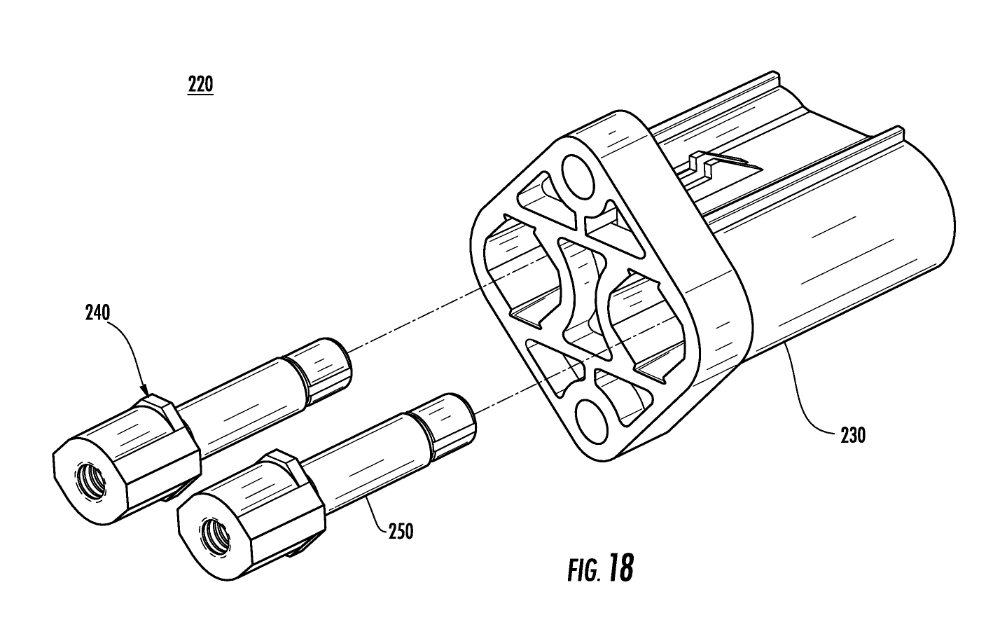

Similarly as shown in FIGS. 16 and 18 the plug connector 220 includes a housing 230 and a terminal assembly 240 that is configured to be retained within the housing 230. The terminal assembly 240 includes a terminal 250 with an insulative endcap secured to the terminal. Upon assembly of the terminal assembly into the housing 230, a touch safe zone is defined at the mating end of the plug 220. A gap is formed between the walls of the cavity formed in the housing 230 and the endcap of the terminal assembly 240. The gap is configured to restrict the insertion of the finger probe as described above and therefore defining the plug 220 as touch safe.

It can be appreciated that the current disclosure shows a square male and female terminal arrangement but other geometries can be used, such as circular and rectangular configurations.

The disclosure provided herein describes features in terms of preferred and exemplary embodiments thereof. Numerous other embodiments, modifications and variations within the scope and spirit of the appended claims will occur to persons of ordinary skill in the art from a review of this disclosure.

We claim:

1. A connector comprising:
a housing formed from an insulative material, the housing includes a mating section and a mounting section, the mating section includes an opening configured for receiving a portion of a mating connector, the housing further includes a silo formed in the opening, a cavity is formed in the silo and communicates with the mounting section;
a terminal, the terminal having a base portion, a contact portion extending from a first area of the base portion and a securing portion extending from a second area of the base portion, spring fingers are formed around a periphery of the contact portion defining an interior space, a peg formed from an insulating material is disposed in the interior space; and
wherein a receiving slot is defined between the silo and the peg.

2. The connector according to claim 1, wherein the peg includes a blocking end that extends beyond the spring fingers in a mating direction.

3. The connector according to claim 2 wherein the silo includes an end adjacent the mating section of the housing and the blocking end of the peg is positioned between the end of the silo and the spring fingers.

4. The connector according to claim 2, wherein the blocking end of the peg extends beyond the mating section of the housing.

5. The connector according to claim 2, wherein a first distance defined between the silo and the blocking end of the peg is less than a second distance defined by a finger test probe.

6. The connector according to claim 5, wherein the finger test probe conforms to standard UL1950.

7. The connector according to claim 1, wherein the connection slot is defined around an exterior profile of the peg and the spring fingers.

8. The connector according to claim 1, wherein the peg is secured to the terminal by a pin.

9. The connector according to claim 1, wherein the periphery of the contact portion is rectangular.

10. A connector system comprising:
a first connector, the first connector having a first housing formed from an insulative material, the first housing includes a first mating section and a first mounting section, the first mating section includes an opening, the first housing further includes a silo formed in the opening, a cavity is formed in the silo and communicates with the first mounting section, the first connector further having a first terminal, the first terminal fitted in the cavity, the first terminal having a base portion, a contact portion having a periphery, the contact section extending from a first end of the base portion and a securing portion extending from a second end of the base portion, spring fingers are formed around the periphery of the contact portion defining an internal space, a peg formed from an insulating material is disposed in the internal space and a slot is defined between the silo and the peg;
a second connector, the second connector having a second housing formed from an insulative material, the second housing includes a second mating section and a second mounting second, the second mating section configured to be inserted into the first mating section of the first connector along a mating direction, a retention portion is formed in the second mounting section, the second connector further having a second terminal, the second terminal includes a second base portion and a second contact portion extending from the second base portion along the mating direction, the second base portion of the second terminal is secured in the retention portion of the second housing, the second contact portion of the second terminal having a second periphery with a second internal space, the contact portion further includes an insulative cap attached to an end of the contact portion of the second terminal; and
wherein the contact section of the second terminal is disposed in the slot of the first connector with the spring fingers of the first terminal engaging the contact section of the second terminal and the peg of the first terminal is disposed in the internal space of the second terminal when the first connector and the second connector are mated together.

11. The connector system according to claim 10, wherein the silo of the first connector is interleaved between the second housing and the second terminal of the second connector.

12. The connector system according to claim 10, wherein the second contact portion of the second connector is interleaved between the peg and spring fingers of the fist terminal of the first connector.

13. The connector system according to claim 10, wherein the first and second peripheries are rectangular.

14. The connector system according to claim 10, wherein the first and second peripheries are circular.

15. The connector system according to claim 10, wherein the peg of the first terminal of the first connector includes a blocking end that extends beyond the spring fingers of the first terminal of the first connector in a mating direction.

16. The connector system according to claim 15, wherein the blocking end of the peg extends beyond the mating section of the housing.

17. The connector system according to claim 15, wherein a first distance defined between the silo and the blocking end of the peg is less than a second distance defined by a finger test probe.

18. The connector system according to claim 17, wherein the finger test probe conforms to standard UL1950.

19. The connector system according to claim 10, wherein a third distance defined between the second housing and insulative cap of the second connector is less than a second distance defined by a finger test probe.

20. The connector system of claim 10, wherein the peg is secured to the first terminal of the first connector by a pin.
